(19) United States
(12) Patent Application Publication
(10) Pub. No.: US 2002/0133558 A1
(43) Pub. Date: Sep. 19, 2002

(54) Large hotel entertainment and/or information system

(76) Inventors: James L. Fenno, Sioux Falls, SD (US); Brian P. Pelletier, Brandon, SD (US); Prentice J. Plucker, Chancellor, SD (US); Shaun E. Marko, Columbia, MO (US); John S. Prince III, Sioux Falls, SD (US); Paul A. Johnson, Sioux Falls, SD (US)

Correspondence Address: SHERIDAN ROSS PC, 1560 BROADWAY, SUITE 1200, DENVER, CO, 80202

(21) Appl. No.: 09/809,519

(22) Filed: Mar. 14, 2001

(51) Int. Cl. H04N 7/18; G06F 15/16

(52) U.S. Cl. 709/208; 725/78

(57) ABSTRACT

A hotel entertainment system adaptable to provide entertainment services to a large or small lodging facility is provided. The system comprises a master host and several slave subsystems, which communicate via a network backbone. The slave subsystems provide entertainment services to guest rooms, and the master host coordinates communications between the slave subsystems and other components of the hotel entertainment system. The master host can connect to a number of slave subsystems with the slave subsystems providing services to a subset of the guest rooms in a lodging facility, allowing the system to be scaled to provide entertainment services to lodging facilities of varying sizes. The master host contains a room map and a property management system daemon. The room map allows the master host to determine which guest rooms are by a particular slave subsystem, allowing accurate tracking of which guest room receives services. The property management system daemon communicates this information to the hotel property management system, which tracks billing and room information for all the guest rooms in a lodging facility. The slave subsystems include a slave host and several services subsystems. The slave host has a property management system interface daemon, which communicates with the property management system daemon in the master host to receive guest room status updates and send guest room services information. The master host also coordinates delivery of new video content schedules to the slave subsystems. A slave subsystem failure only affects the guest rooms that a particular slave subsystem services, and the slave subsystems are capable of providing entertainment services to the guest rooms when the master host is off-line, thus reducing the effects of any system failures.

### FIELD OF THE INVENTION

The present invention relates to hotel systems, and, in particular, to scalable systems capable of providing entertainment and/or information services to a large number of hotel guest rooms.

### BACKGROUND OF THE INVENTION

In recent years, the use of hotel service systems to provide in-room entertainment and/or information services has become increasingly widespread. Such entertainment systems often include the provision of free television programming, pay-per-view movies, video games, and Internet access. Such systems often also allow the guest to order hotel services such as laundry services and room service, and can provide alternative check-out services. Further potential uses of such a system not envisioned today may also be available in the future.

Such systems typically include a host computer which is connected to different subsystems which provide the entertainment services to a guest room. The host computer manages the requests from the guest rooms and sends commands to the different subsystems which in turn provide the service to the guest room. Thus, the host computer does not directly provide the services, but manages the requests and commands for the services.

There are typically subsystems for each type of entertainment service provided. For pay-per-view movies, for example, there is a video content server (VCS), or a digital content server (DCS), which provides the movies for viewing in the guest room. When a guest orders a pay-per-view movie, the host computer records the order, and gives a command to the video or digital content server to provide the movie to that particular guest room. Likewise, if a guest wishes to play a video game, the host computer receives and records the request and coordinates with a video game engine which provides the video games to the guest room. Also, if a guest wishes to use an Internet based service, the host computer receives and records the request, and coordinates with an Internet browser which provides the Internet service to the guest room.

The host computer also typically coordinates with a property management system (PMS). The PMS is the system used by a hotel to track room status and charges. When a host computer records a services request, it also communicates this information to the PMS, which in turn adds the charge for the service to the bill for the room. The host computer can then also provide services to the guest room which come from the PMS. For example, a guest can access a list of current room charges and check out from the guest room. Additionally, a guest can use this feature to perform other functions, such as laundry services or room services.

By means of the host computer controlling a number of service sub-systems, a single computer can coordinate the services for a number of guest rooms. Typically, in such a system, the host computer can control the services for up to 1200 guest rooms. The host computer typically includes a CPU, a memory, an intelligent communications processor card (ICP), a serial port board, a SCSI board, and a network interface card (NIC). The ICP functions to connect the host computer to the guest rooms. The SCSI board connects the host computer to the video game engine subsystems. The NIC connects the host computer to an ethernet switch which connects to several Internet browser subsystems. The serial port board connects to devices which use serial communications, such as the PMS and a modem.

The ICP is capable of connecting a preset number of guest rooms to the host computer, with each room having a connection to the ICP. Thus, if an ICP has 200 connectors, it can serve 200 rooms. If a hotel has more than this amount of rooms, additional ICP boards may be added to the host computer to serve the additional rooms. For example, if a hotel has 1200 guest rooms, six ICP boards would be needed to service all of the rooms. The ICP board typically connects to the host computer via an ISA interface in the host computer. As a host computer has a limited number of ISA interfaces, a facility may have more guest rooms than can be connected to a host computer. For large hotels, the number of guest rooms may be greater than the total number of ICP-to-guest room connections. Using the above example, if a host computer has six ISA slots available, the system can service a maximum of 1200 guest rooms. Thus, for a large facility, the system must be modified, or a different system must be used, to accommodate all of the guest rooms.

Traditionally, to overcome this performance problem, systems have been modified to suit the specific needs of an individual hotel. These customized systems may include modified systems which can accommodate additional ICP cards, or two or more separate systems installed for a facility which are coordinated to provide services. However, this creates a new set of problems. For example, the amount of time and resources to design and install the custom designed system increases dramatically, as each system for a large hotel is unique. This increases the cost of the system, and also can also degrade the quality and reliability of the system. Additionally, if problems do arise, they can be more difficult to troubleshoot since the system is not uniform, and a technician servicing the system needs to learn the differences of that particular system, possibly increasing downtime associated with a failure. Thus, it would be advantageous to have a scalable system, capable of using standard configuration host computers to connect any number of guest rooms.

However, even with standard systems, a host computer can suffer periods of downtime. This downtime may be the result of a hardware or software failure, or routine maintenance on the system. For a lodging facility, this may mean that all of the rooms are without the services of the system during the period of downtime. This may cause customer dissatisfaction and loss of revenue for the facility. Additionally, as the guests may no longer check out of the hotel directly from the room during these downtime periods, more guests must come to the front desk to check out, causing increased wait times for the check-out, which can also cause customer dissatisfaction. Thus, it would also be advantageous to have a system which reduces system downtime, and also minimizes the effect of downtime to as few guest rooms as possible.

Accordingly, it would be advantageous to have an entertainment services system which: (1) has standard components which are configurable to meet the needs of both small and large facilities, (2) is more resistant to failures, and reduces the effects of such failures, and (3) is scalable such that it can accept additional guest rooms, and/or additional services without costly modifications to the system.

### SUMMARY OF THE INVENTION

The present invention is designed to overcome the aforementioned problems and meet the aforementioned, and other, needs. The present invention provides a system and method for providing entertainment services in a lodging facility. The services can include entertainment services and/or information services, which may be provided in a large or small lodging facility.

The system includes a plurality of slave subsystems, including at least a first slave subsystem having a first slave host and a second slave subsystem having a second slave host.

Each slave subsystem is associated with a group of rooms in the lodging facility, with the first slave subsystem being associated with a first group of rooms and the second slave subsystem being associated with a second group of rooms. Each of the slave hosts performs a first set of functions. The system also includes a master host, which performs a second set of functions. The master host is connected to several master host subsystems. A communications interface enables communications between each of the slave hosts and the master host.

The master host subsystems include a property management system interface, a front office terminal, an Internet router, and a modem. The functions performed by the master host relate to communications and control of the master host subsystems. The master host controls communications between the property management system and the slave hosts via its property management system interface. The master host also supervises access to the front office terminal to enable terminal related communications to be received by a desired slave host. Additionally, the master host secures a connection to the Internet for one or more of the slave hosts, and provides a connection to the modem which may be used for remote access to the master host which may in turn provide access to any of the slave hosts.

In one embodiment, the system includes one or more digital content receivers also, a digital content server is included in at least one of the slave host subsystems. The slave host is configured to receive content from the digital content receiver and store it on the digital content server. When the content transfer is complete, the slave host notifies the master host. When the master host receives notification that all of the slave hosts have transferred the content, it coordinates the removal of the content from the digital content receiver.

The master host stores room map information that correlates each room of the lodging facility with one of the slave hosts. The master host also has menu information related to identification of the first slave host as being responsible for the first group of rooms and has menu options for producing reports to obtain data from each of the slave hosts. Additionally, the master host has menu options that allow configuration changes to be propagated to all of the slave hosts. The master host is also capable of installing configuration changes to the slave hosts.

The slave host controls several functions for the group of rooms it is associated with. These functions include controlling game engine operations, controlling playing of movies, receiving transaction information, and storing guest information. Each of the slave hosts are associated with host-specific configurations and global configurations. The host-specific configurations include information related to an Internet browser service, including a number of browsers to be associated with each of the slave hosts. The global configurations include an Internet protocol (IP) address for each slave host. These slave host IP addresses are not routable over the Internet. The master host has an IP address, which is routable over the Internet, thus all Internet communications are routed through the master host.

Communications between the property management system and the slave hosts are conducted through the master host. The master host and slave hosts communicate over a network using Internet protocol. The first slave host includes a first server application, and the master host includes a second server application. The first server accepts requests from other applications and transfers requests for communications with the property management system to the second server on the master host. The first server also obtains information in connection with fulfilling requests associated with the first slave subsystem. The second server formats requests based on protocol of the property management system and interprets responses based on requests sent to the property management system.

In one embodiment, a slave property management interface daemon (Slave PMID) is executed using the first server. A host property management system interface daemon (host PMID) is executed using the second server. The first slave host thus receives commands from the guest rooms, and stores guest information, which includes transactions for a first group of rooms associated with the first slave host and identification information associated with the first group of rooms. The first slave host communicates this guest information to the master host. The master host formats this guest information and provides the information to the property management system. The master host also transmits command information from a front terminal to the slave hosts.

In one embodiment, the master host and the slave hosts use the same server. On the slave host, the server operates in slave mode, relaying requests to communicate with the property management system to the master host. On the master host, the server operates to receive and format the requests. The master host server then sends the requests to the property management system and interprets the responses.

Based on the foregoing summary, a number of advantages of the present invention are noted. A standardized system is provided which may be used to provide entertainment services to a large number of guest rooms in a lodging facility. The system is scalable such that additional guest rooms may be added to an existing system without the need to make substantial modifications to the original system. Likewise, additional entertainment services may be added without the need to substantially modify the original system. Additionally, the slave hosts can buffer transactions, allowing the master host to go down without disrupting entertainment services to guest rooms. Likewise, if a slave subsystem goes down, the group of rooms associated with that slave subsystem are affected, limiting the services interruption to less than all of the guest rooms in a lodging facility.

Other features and advantages of the invention will be apparent from the following specification taken in conjunction with the following drawings.

### BRIEF DESCRIPTION OF THE DRAWINGS

FIG. 1 is a block diagram representation of the large hotel entertainment system of the present invention;

FIG. 2 is a block diagram representation of the master host and associated subsystems;

FIG. 3 is a block diagram representation of a slave subsystem;

FIG. 4 is a flow chart depicting the communications from a slave host to the PMS;

FIG. 5 is a flow chart depicting the communications from the PMS to a slave host;

FIG. 6 is a block diagram representation of a digital content transmitter and digital content receiver;

FIG. 7 is a flow chart depicting the distribution of video content and schedule information from a digital content receiver to the slave subsystems; and

FIG. 8 is a flow chart depicting the automated upgrade installation of one embodiment of the present invention.

### DETAILED DESCRIPTION

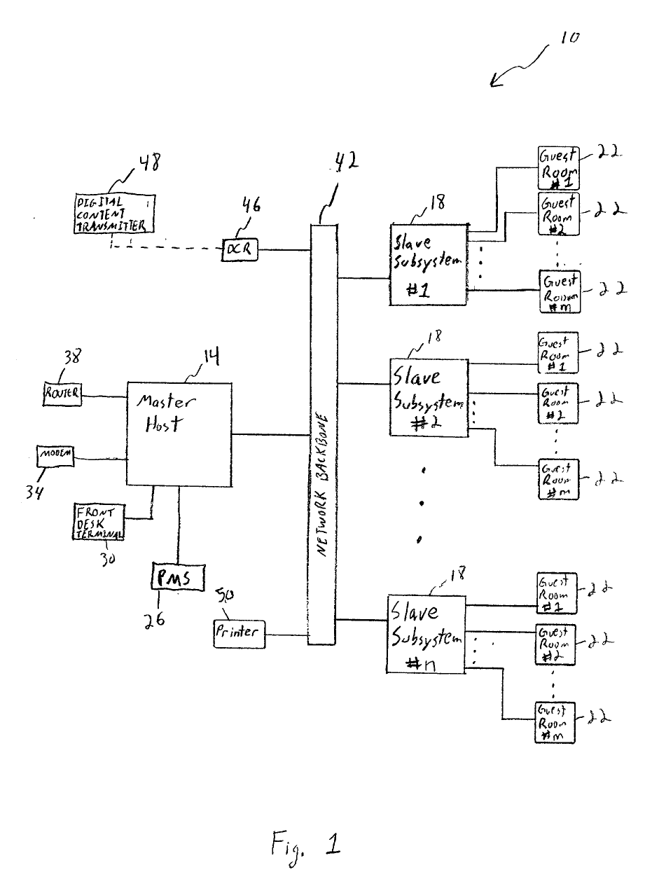

With reference to FIG. 1, a block diagram representation of a system of the present invention is shown. The hotel entertainment system 10 includes a master host 14 and a plurality of slave subsystems 18. The slave subsystems 18 connect to a plurality of guest rooms 22 and provide entertainment and other services thereto. The master host 14 is connected to a hotel property management system (PMS) 26, a front desk terminal 30, a modem 34, and a router 38. The master host 14 and the slave subsystems 18 communicate over a network backbone 42. The network backbone 42 may be a wire or fiber optic network connection, or may be a wireless connection such as a radio or optic connection. In one embodiment, the network backbone 42 is a 100 Mbit ethernet connection. Also attached to the network backbone 42 is at least one digital content receiver (DCR) 46 and a printer system 50. The DCR 46 receives digital content from a digital content transmitter 48. The printer system 50 is used for various print jobs in which a paper copy of a document is needed.

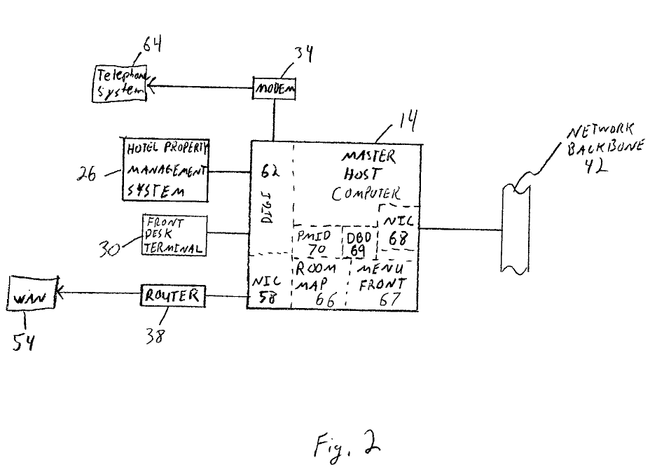

With reference now to FIG. 2, the master host 14 is next described. The master host 14, as mentioned above, is connected to a router 38, a modem 34, a PMS 26, and a front desk terminal 30. The router 38 is used to connect the master host 14 to a wide area network (WAN) 54, such as the Internet. The router 38 is connected to the master host 14 through a network interface card 58. The IP address for this network interface card 58 is routable over the WAN. Thus the master host 14 can communicate over the Internet or other network which operates using Internet protocol. The modem 34 is connected to the master host 14 through a serial communications interface 62. The modem 34 is used to connect the master host 14 to a serial communications network over a standard telephone system 64.

The PMS 26 is a system used by the lodging facility to provide billing and room information for all the guest rooms in the lodging facility. The PMS 26 is connected to the master host 14 by a serial connection through the serial communications interface 62. The PMS 26 receives and provides information, as will be described in detail below, to the master host 14 as well as the slave subsystems 18. The PMS 26 records the activity and status of each room in the lodging facility. For example, if a guest orders a movie, the PMS 26 records the time and date of the movie order, and adds an appropriate charge to the bill for the room. Within the master host 14, there is a room map 66 which maps particular rooms in the lodging facility, and a master database daemon (DBD) 69 which provides updates to room status. The creation and maintenance of the room map 66 and master DBD 69 will be described in more detail below.

The front desk terminal 30 is also connected to the master host 14 through the serial communications interface 62. The front desk terminal 30 is a user interface to the master host 14. In one embodiment, the master host 14 and slave subsystems 18 operate using a UNIX platform, and the front desk terminal 30 is a standard user terminal for a UNIX system, such as a WYSE terminal. The front desk terminal 30 user interface may be a menu interface or a graphical interface. In the embodiment shown, the user interface is a menu interface, with the master host 14 containing a menu front 67. The menu front 67 provides a menu interface for the master host 14 and for the slave subsystems 18, allowing a single front desk terminal 30 to be used to provide user access to the master host 14, as well as all of the slave subsystems 18. The master host 14 also includes a second network interface card 68. The second network interface card 68 is used to communicate with the slave subsystems 18, printer 50 and DCR 46 via the network backbone 42.

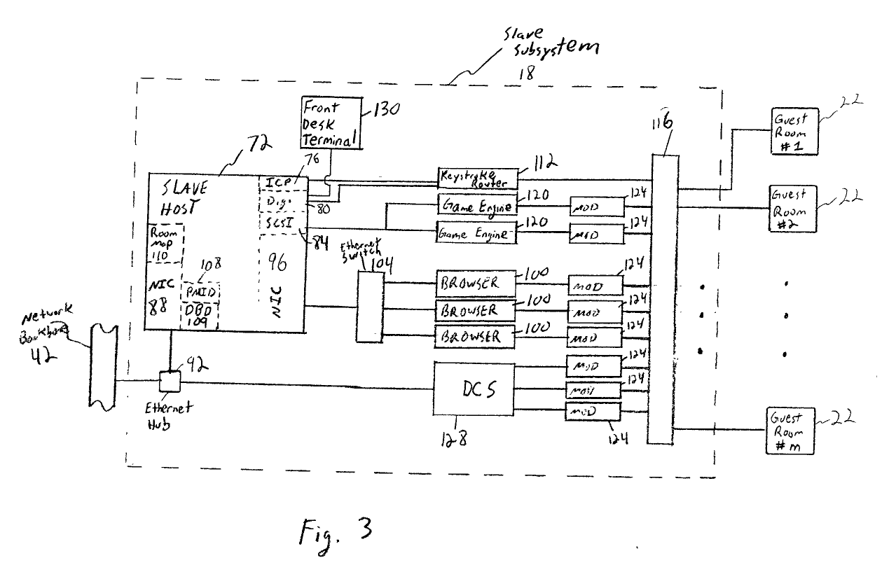

With reference now to FIG. 3, the slave subsystems 18 are now described. FIG. 3 shows a block diagram representation of a slave subsystem 18. Each slave subsystem 18 includes a slave host 72 which is connected to several guest rooms 22 and also coordinates with several components to provide services to the guest rooms 22. Each slave host 72 has an intelligent communications processor (ICP) card 76, and a serial communications card 80, which connect to each guest room 22 served by that particular slave subsystem 18. The ICP 76 and the serial communications card 80 receive communications from the guest rooms 22, as is well understood in the art.

Each slave host 72 also contains a SCSI interface board 84, and a third network interface card 88 connected to an ethernet hub 92 and a fourth network interface card 96 connected to Internet browser engines 100 through an ethernet switch 104. Additionally, each slave host 72 contains a slave property management interface daemon (slave PMID) 108 a slave database daemon (DBD) 109, and a slave room map 110. The functions and operation of the slave PMID 108 slave DBD 109, and slave room map 110 will be described subsequently.

Each slave subsystem 18 is coordinated with several components which provide services to a guest room 22. One of these components is a keystroke router 112. The keystroke router 112 is connected to both the serial communications interface board 80 and the ICP board 76. The keystroke router 112 is connected to each guest room through a switch 116. A guest in a guest room 22 communicates to the slave host 72 through the keystroke router 112. The keystroke router 112 may receive input from several places. One method is a menu which may be operated through the guest room television, in which the guest can select and order services to be provided to the guest room 22. The guest room 22 may also communicate to the slave host 72 through an Internet browser interface such as a mouse and keyboard. The Internet browser interface may also include other types of interfaces, such as touch screens. The Internet browser interface communicates to the slave host 72 through the switch 116, the keystroke router 112 and the serial communication board 80. Additionally, if game services are provided, the guest room will have a game controller pad which sends input through the switch 116, the keystroke router 112 and the serial communications board 80.

Each slave subsystem 18 also includes a number of game engines 120. Each game engine 120 is capable of providing a video game service to a guest room 22. The slave host 72 controls each game engine 120 through the SCSI interface board 84. The game engines 120 are connected to guest rooms 22 via a modulator 124 and switch 116. Each slave subsystem 18 also includes a number of Internet browser engines 100. The Internet browser engines 100 are connected to each guest room 22 via a modulator 124 and the switch 116. The Internet browser engines 100 are connected to the slave host 72 via an ethernet switch 104 which is connected to the fourth network interface card 96.

In one embodiment, the slave host 72 is connected to a second front desk terminal 130. In this embodiment, the slave host 72 provides a connection to the master host 14 for the second front desk terminal 130. This allows the second front desk terminal 130 to be located, for example, in a property building that is remote from the master host 14. Thus, front desk terminal access can be obtained without exceeding the length that a serial connections line will permit.

Each slave host 72 is also connected to a digital content server (DCS) 128. The DCS 128 provides movies, and other video content, to the guest rooms 22 via a modulator 124 and the switch 116. Each DCS 128 can serve a number of rooms, and communicates to the slave host 72 via the ethernet hub 92 and the third network interface card 88.

In a preferred embodiment, communications between the master host 14 and the slave hosts 72 are conducted over an ethernet connection. In this embodiment, the network interface cards are 10/100 Mb ethernet network interface cards. The preferred network speed is 100 Mb to facilitate the transfer of large files. If the master host 14 and slave subsystems 18 are all located within the same building, all of the hosts will communicate via a switched 100 Mb Ethernet loop. If a site includes several buildings, hosts in different buildings may communicate over a wireless link if an Ethernet loop is not available. If the speed of a link is slow, thus making transfer of large files impractical, each building may also be equipped with its own DCR. In one embodiment, each of the master host 14 and slave hosts 72 is assigned an IP address from the RFC 1918 network 192.168/16. These addresses are not routable over the Internet. The master host 14 serves as the Internet gateway for the Internet browser services running on the slave subsystems, therefore the default route of each slave will be set to IP addresses of the master host.

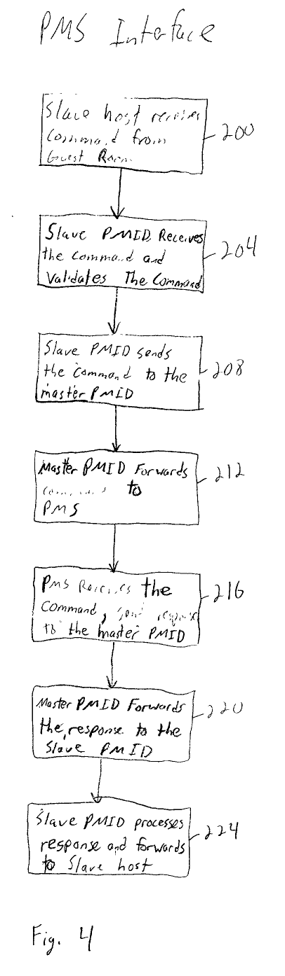

With reference now to FIGS. 1-4, the communication between the slave subsystems 18, master host 14 and PMS 26 will now be described. FIG. 4 is a flow chart showing the steps for communication between the slave subsystems 18 and the PMS 26. First, as shown in block 200, the slave host 73 receives a command from a guest room 22. As mentioned above, each slave host 72 contains a slave PMID 108. The slave PMID 108 is a daemon program which runs in the background of each slave host 72, and implements functions related to collecting information required by the PMS 26. In one embodiment, the master host 14 and slave host 72 use the same PMID server. On the slave host 72, the slave PMID 108 operates in slave mode, relaying requests to communicate with the PMS 26 to the master host 14. On the master host, 14, the host PMID 70 operates to receive and format the requests. The host PMID 70 then sends the requests to the PMS 26, and interprets the responses. When a slave host 72 receives a command from the guest room 22 to provide a service, the slave PMID 108 receives and validates the command, shown in block 204. The slave PMID 108 then sends the command to the host PMID 70, shown in block 208. Like the slave PMID 108, the host PMID 70 is a daemon program which runs in the background of the master host 14 computer, and implements functions related to collecting information required by the PMS 26. The host PMID 70 forwards the command to the PMS 26, as shown in block 212. The PMS 26 then receives the command and sends a response to the host PMID 70, as shown in block 216. The host PMID 70 forwards this response to the slave PMID 108, as shown in block 220. The slave PMID 108 then processes the response, and forwards it to the slave host 72 which will then coordinate for the service to be provided to the guest room 22, shown in block 224.

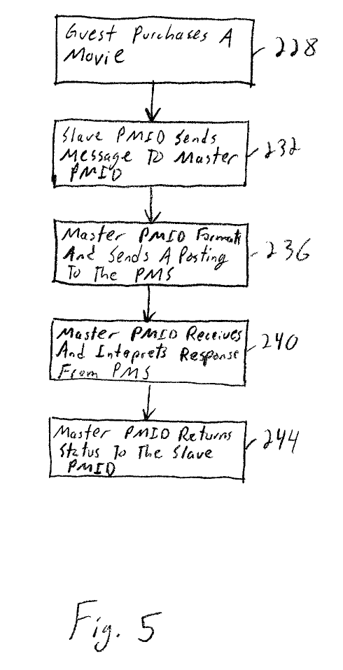

With reference now to FIG. 5, the communication from the PMS 26 to the slave host 72 will now be described. Such a communication typically contains information regarding changes in guest room status, which is stored in a database within the slave PMID. First, the PMS 26 sends a command to the host PMID 70, as shown in block 228. The host PMID 70 validates the command and forwards it to the slave PMID 108, shown in block 232. The slave PMID 108 then updates its database, shown in block 236. The slave PMID 108 verifies the update status, and returns this status to the host PMID 70, as shown in block 240. The host PMID 70 receives the update status, shown in block 244. The host PMID 70 then forwards the response to the PMS 26, shown in block 248.

As mentioned above, the master host 14 also contains a room map 66. The master host 14 must know which rooms each slave host 72 controls. For example, if the hotel PMS 26 checks in a room and sends the PMS 26 a check in message, the master host 14 must find out which slave host 72 owns the room in question before it can relay the message to that slave host 72. To provide the master host 14 with the room map 66, the customer record in the customer database contains a location field that holds a room number. In addition to the location field, the customer record contains a slave field to record the number of the slave that owns the room. The customer database on the master host 14 can then be used as the room map 66. To insure that the room map 66 is accurate, the host PMID 70 modifies the room map 66 whenever a room status is changed. Since the master host 14 may be offline when a room change occurs on a slave host 72, any changes made to rooms must be updated on the master host 14 when it is returned to service. Likewise, a slave host 72 may be offline when a room change occurs, in which case any changes must be updated on the slave host 72 when it is returned to service.

In one embodiment each slave host 72 also contains a customer database which serves as the slave room map 110. This database contains a room record for each room under the control of the slave host 72. The room record includes the room number, occupancy status (checked in/out), payment method (cash/credit), and any other pertinent information. The master host 14 also contains a customer database which serves as the room map 66 for the master host 14. The room records in the master host 14 customer database contain a slave field to notify the master host which slave host 72 controls the room. The master host 14 requires this information to perform such tasks as routing menu control to a particular slave. Another reason the master host 14 requires the room map 66 is to store occupancy and payment method information about a room in case a slave host 72 is down. The PMS 26 sends checkin/checkout commands to the host PMID 70. When a customer checks in, the PMS checkin command also indicates the payment method (cash or credit). The master DBD 69 monitors the master host 14 customer database for changes and sends all updates to the correct slave, if possible. If the slave has been down and returns to service, the slave host DBD 109 server will request a customer database update from the master host DBD 69 server. The slave hosts 72 contain a transaction database that contains all information about transactions and adjustments. Several applications can query this database to create different reports as required for hotel management. In order to create these reports, a read-only copy of the slave transaction databases is created on the master host. In one embodiment, the slave host DBD 109 server sends all new transaction information to the master DBD 69 server. If the master host 14 is down and returns to service, the host DBD 69 server requests a transaction database update from all slaves to ensure it is up to date. By having a copy of all transactions on the master host 14, transaction report applications can be executed on the master host 14 to produce site-wide reports.

Whenever a customer receives a service through a slave subsystem 18, each slave host 72 stores customer and transaction data in a local database, and forwards this information to the PMS 26 through the master host 14. Each slave host 72 creates a transaction ID for all transactions, with each transaction including information on the slave host, the room, the day and year, the service and the time. In one embodiment, the transaction ID is a 10 digit code. The first digit is the slave ID number, which is a 1-9. Thus, in this embodiment, nine slave subsystems could be used, however, the system could be easily modified to accommodate additional slave subsystems beyond nine. The next two digits in the transaction ID are the last two digits of the year number, starting as 00 for the year 2000. The next three digits are the Julian day of the year, and the last four numbers are a sequence number for the slave for the day. Thus, the transaction ID which is forwarded to the master host 14 contains unique information regarding the room, service and time the service was provided. The host PMID 70 then uses this information to transfer information to the PMS 26. The host PMID 70 correlates the slave host field in the transaction ID with the guest room that is stored in the transaction ID. The host PMID 70 then forwards this information to the PMS 26, which in turn records the charge to the guest room 22.

The guest may also perform a check out of the facility from the room, in one embodiment. In this embodiment, the guest can initiate a video check out (VCO) procedure from the menu of services available in the guest room 22. The slave host 72 receives the VCO request, and transmits this request to the master host 14, which, in the host PMID 70, correlates the VCO request from the slave host number and room id to correlate the room to the room map 66. The master host 14 then forwards the VCO request to the PMS 26, which sends a folio showing current room charges to the master host 14, which in turn forwards this information to the slave host 72 and the guest room 22. The guest can approve these charges, which is sent to the slave host 72 and the master host 14, and then to the PMS 26, thus completing the check out procedure.

In the event that the master host 14 is not available or cannot communicate with the slave host 72, the slave host 72 will buffer transactions. In this case, the slave host 72 will allow the service to be delivered to the guest room 22. The slave host 72 will record the transaction and will transfer it to the master host 14 when the master host 14 can again communicate to the slave host 72. In one embodiment, the master DBD 69 will request a database update from the slave DBD 109 to get any buffered transactions. In such a case, many services will not be disrupted to the guest room 22. Services which will be interrupted are services which require interaction with the master host 14, including the Internet service which needs to go through the master host 14 since the master host 14 has the only IP address which is routable to the WAN. Other services which would be unavailable if the master host 14 was down include the VCO service, as well as other services requiring information from the PMS 26, such as laundry or room services.

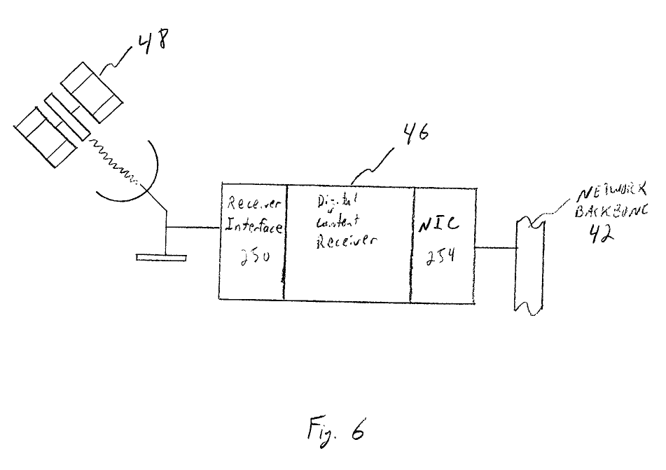

With reference now to FIGS. 1-3, 6 and 7, the receipt and delivery of video content will be described. Initially, video content is received at the DCR 46 from the digital content transmitter 48. The DCR 46 contains a receiver interface 250 and a network interface card 254. The receiver interface 250 is used to interface with the digital content transmitter 48. In one embodiment the receiver interface 250 is a satellite receiving antenna and associated hardware, although other receiving apparatus for other modes of communication could also be used. The NIC 254 connects the DCR 46 to the network backbone 42, and in one embodiment is a 10/100 Mb Ethernet network interface card. When content is received at the DCR 46, the content must be transferred to the different DCS 128 units on each of the slave subsystems 18. When content is delivered, the DCR 46 stores the new content and waits to transfer the content to the DCS 128 units. When the master host 14 receives a new content schedule, it initiates a routine which will provide this new content to each of the DCS 128 units in the slave subsystems 18.

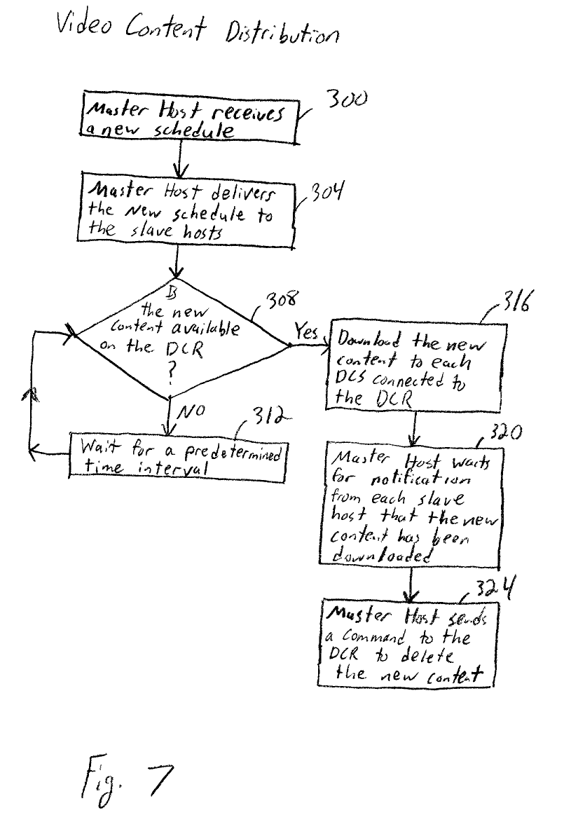

FIG. 7 shows a flow chart depicting the routine for delivery of new content and new schedule information, such as a new movie which is offered at preset times, to each of the slave subsystems. The DCS 128 units are controlled by the slave host 72, and typically offer certain movies at certain times. When a new video content schedule becomes available, the new content must be loaded on each DCS 128. Alternatively, the DCS 128 may be a video on demand system, in which there is no preset schedule, and when a guest orders video content to be delivered to the guest room 22, the delivery occurs immediately, and not on a preset schedule. Even in this case, however, each DCS must receive the new video content, and the title of the new content must be made available for a guest to select in ordering, thus the routine for delivery of content is applicable to both scheduled video content and video on demand.

Initially, a new content schedule is sent to the master host 14, shown in block 300. The new content schedule may be delivered via the modem 34, the WAN 54, or via the DCR 46. The master host 14 then delivers the new content schedule to each slave host 72, shown in block 304. Each slave host 72 then determines whether the new content is available on the DCR 46, shown in block 308. If the new content is not available, the slave host 72 waits for a predetermined time period, shown in block 312, and checks again for the new content, shown in block 308. When the slave host 72 determines that the new content is available, it downloads the new content to its DCS 128, shown in block 316. When the slave host 72 has successfully downloaded the new content, it sends a notification to the master host 14. The master host 14 waits for notification from each slave host 72, shown in block 320. Finally, shown in block 324, after receiving notification from each slave host 72, the master host 14 sends a command to the DCR 46 to delete the new content from DCR 46 memory.

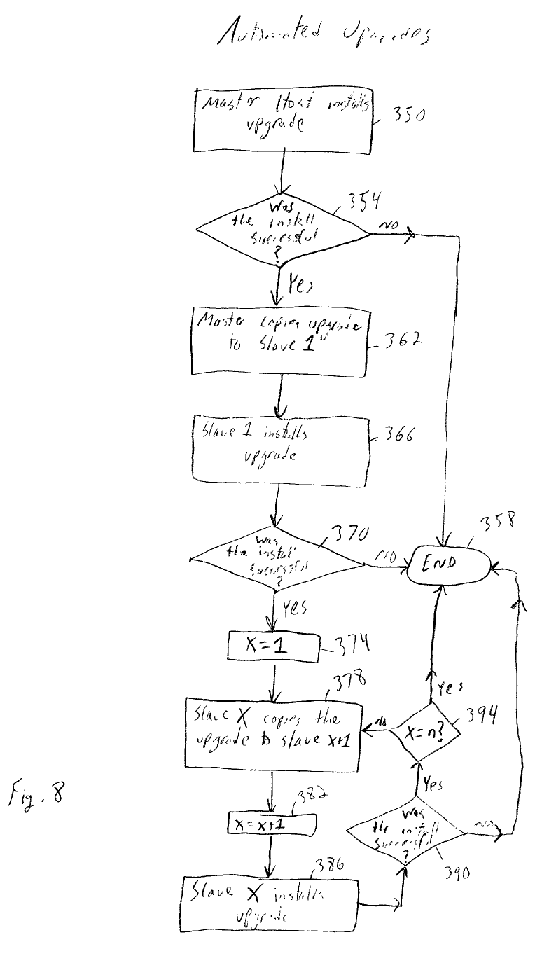

Additionally, in one embodiment, now described with reference to FIG. 8, the system can automatically upgrade the software that is operating on the system. In such a case, the master host receives the upgrade package from a central location. This upgrade information can come from a remote location via the Internet connection, or the modem, for example. Once the master host has the software upgrade package, it executes the package to install the software upgrade on the master host, shown in block 350. The master host then checks to verify that the install was successful, shown in block 354. In the event of an unsuccessful upgrade, the routine ends, shown in block, and user intervention is required. If the event that the upgrade was successful, the master host copies the upgrade to slave host number 1, shown in block 362. The slave host number 1 then installs the upgrade, shown in block 366. The slave host 1 then checks to verify that the software upgrade was successful, shown in block 370. In the event that the upgrade was not successful, the routine ends, and user intervention is required, shown in block 358. In the event that the upgrade was successful, the slave host number one sets an internal counter, X, to one, as shown in block 374. Slave one then copies the upgrade to slave host number X+1, shown in block 378. The slave host number one then increments the counter, shown in block 382. Slave host number X then installs the upgrade, shown in block 386. If the upgrade was not successful, the routine ends, shown in block 358, and user intervention is required. If the install was successful, the slave host X checks to determine if the internal counter, X, is equal to the total number of slave hosts present in the system, as shown in block 394. If X is equal to the total number of slave hosts, the routine ends, shown in block 358, and no user intervention is required. If X is less than the total number of slave hosts present in the system, the slave host X copies the software upgrade to slave host number X+1, and the steps shown in blocks 378 through 394 are repeated.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best modes presently known of practicing the inventions and to enable others skilled in the art to utilize the inventions in such, or in other embodiments, and with the various modifications required by their particular application or uses of the invention. It is intended that the appended claims be construed to include alternative embodiments to the extent permitted by the prior art.

What is claimed is:

1. A system for providing information and/or entertainment services in one or more lodging facilities, comprising:
a plurality of slave subsystems having a plurality of slave hosts and including at least a first slave subsystem having a first slave host and a second slave subsystem having a second slave host, each of said plurality of slave subsystems being associated with a group of rooms in at least one lodging facility and in which said first slave subsystem is associated with a first group of rooms and said second slave subsystem is associated with a second group of rooms, each of said slave hosts being involved with a first set of functions;
a master host being involved with a second set of functions;
a communications interface that enables communications between each of said plurality of slave hosts and said master host; and
a plurality of master host subsystems connected to said master host.

2. A system, as claimed in claim 1, wherein:
said plurality of master host subsystems includes a number of the following: property management system, a front office terminal, an Internet router, and a modem.

3. A system, as claimed in claim 2, wherein:
said second set of functions includes a plurality of the following: controlling communications between said property management system and said plurality of slave hosts; supervising access to said front office terminal to enable terminal related communications to be received by a desired slave host of said plurality of slave hosts; securing connection to the Internet for one or more of said plurality of slave hosts; and obtaining a connection to said modem.

4. A system, as claimed in claim 1, wherein:
said plurality of master host subsystems includes at least a first digital content receiver (DCR) and at least said first slave subsystem includes a first digital content server (DCS) and in which said first slave subsystem downloads content from said DCR to said DCS.

5. A system, as claimed in claim 1, wherein:
said master host obtains statistical report information from each of said plurality of slave subsystems and said statistical report information includes identification information of each of said plurality of slave hosts.

6. A system, as claimed in claim 1, wherein:
said master host stores room map information that correlates each room of the lodging facility with one of said slave hosts.

7. A system, as claimed in claim 1, wherein:
said master host has menu information including related to identification of said first slave host as being responsible for the first group of rooms, menu options involved with producing reports to obtain data from each of said slave hosts, and menu options that allow configuration changes to be propagated to all of said slave hosts.

8. A system, as claimed in claim 1, wherein:
said master host is used to install changes to said slave hosts.

9. A system, as claimed in claim 1, wherein:
said first set of functions includes: controlling game engine operations for a predetermined group of rooms of at least one lodging facility; controlling playing of movies for a predetermined group of rooms of at least one lodging facility; receiving transaction information associated with a predetermined group of rooms of at least one lodging facility; and storing guest information associated with a predetermined group of rooms of at least one lodging facility.

10. A system, as claimed in claim 1, wherein:
each of said slave hosts is associated with host-specific configurations and global configurations and in which said host-specific configurations include information related to an Internet browser service including a number of browsers to be associated with each of said slave hosts.

11. A system, as claimed in claim 3, wherein:
said first slave host includes a first server and said master host includes a second server, said first server accepts requests and transfers data relative to said property management system through said master host and obtains information in connection with fulfilling requests associated with at least said first slave subsystem, said second server formatting requests based on protocol of said property management system and interpreting responses based on requests sent to said property management system.

12. A system, as claimed in claim 3, wherein:
each of said master host and said plurality of slave host has an IP (Internet Protocol) address and in which only said IP address of said master host is routable over the Internet.

13. A system, as claimed in claim 4, wherein:
said second slave subsystem has a second DCS and in which said first slave subsystem and said second slave subsystem control downloading content to each of said first and second DCSs such that a downloading to said first DCS is conducted at a time differently from downloading to said second DCS.

14. A method for providing information and/or entertainment services in at least one lodging facility, comprising:
obtaining guest information by a first slave host of a first slave subsystem of a plurality of slave subsystems,
communicating said guest information to a master host in communication with each of said plurality of slave subsystems; and
providing said guest information to a property management system of at least one lodging facility that communicates with said master host.

15. A method, as claimed in claim 14, wherein:
said communicating step includes utilizing a first server executing on said first slave host to transfer said guest information to said master host.

16. A method, as claimed in claim 15, wherein:
said providing step includes using a second server executing on said master host and in which said second server formats said guest information to be acceptable to said property management system.

17. A method, as claimed in claim 14, further including:
sending information from said master host that was obtained from one of a plurality of master host subsystems to said first slave host.

18. A method, as claimed in claim 14, further including:
enabling an Internet connection by said master host based on a request from said first slave host.

19. A method, as claimed in claim 14, wherein:
said first slave host performs a plurality of the following: regulating game engine operations for a first group of rooms associated with said first slave host; controlling playing of movies for said first group of rooms; receiving transaction information for said first group of rooms; and storing guest information for said first group of rooms.

20. A method, as claimed in claim 14, further including:
storing information correlating said plurality of slave subsystems to rooms associated therewith.

21. A method for providing entertainment and/or information services in at least one lodging facility, comprising:
providing a master host and a plurality of slave hosts including first and second slave hosts and with each of said plurality of slave hosts being in communication with said master host; and
conducting at least a plurality of the following:
sending information to said master host by said first slave host;
transmitting command information from a front terminal to said first slave host using said master host;
executing a property management system daemon using a server associated with said first slave host;
executing a property management system interface daemon using said master host;
storing guest information using said first slave host and in which said guest information includes transactions for a first group of rooms associated with said first slave host and identification information associated with said first group of rooms;
enabling an Internet connection by said master host based on a request from said first slave host; and
receiving information by said master host from said plurality of slave hosts related to preparing statistical reports.

22. A method, as claimed in claim 21, wherein:
said providing step includes causing said master host and said plurality of slave hosts to communicate on a network.

23. A method, as claimed in claim 21, further including:
associating a room map with said master host in which each of a plurality of rooms is identified using one of said plurality of slave hosts.

24. A method, as claimed in claim 21, further including:
executing a menu option in which a prompt is provided requiring selection of a slave host of said plurality of said slave hosts.

25. A method, as claimed in claim 21, further including:
said first slave host performs a plurality of the following: controlling game engine operations for a first group of rooms of the lodging facility; controlling playing of movies for said first group of grooms; receiving transaction information for said first group of rooms and storing information for said first group of rooms.

26. A method, as claimed in claim 21, further including:
delivering video information to a digital content server.
